(19) United States
(12) Patent Application Publication
(10) Pub. No.: US 2003/0223221 A1
(43) Pub. Date: Dec. 4, 2003

(54) Illuminating device

(75) Inventors: Hsi-Huei Yeh, Shinjuang City (TW); Yih Chang, Chung-Ho City (TW); Mao-Kuo Wei, Hsinchu (TW)

Correspondence Address: BACON & THOMAS, PLLC, 625 SLATERS LANE, FOURTH FLOOR, ALEXANDRIA, VA, 22314

(73) Assignee: RiTdisplay Corporation, Hsin Chu Industrial Park (TW)

(21) Appl. No.: 10/445,954

(22) Filed: May 28, 2003

(30) Foreign Application Priority Data
May 29, 2002 (TW) 91207860

(51) Int. Cl. F21V 9/16

(52) U.S. Cl. 362/84

(57) ABSTRACT

An illuminating device, relating particularly to an OLED illuminating lamp suitable for a dark environment, is disclosed. The device includes an organic light-emitting panel for providing a light source, a translucent diffusive substrate for uniformly diffusing the light source, and a housing having a chamber for receiving the organic light-emitting panel and the translucent diffusive substrate mounted between the organic light-emitting panel and the housing and a window through which passes light emitting from the organic light-emitting panel.

### BACKGROUND OF THE INVENTION

1. Field of the Invention

The present invention relates to an illuminating device, and particularly to an illuminating device suitable for a dark environment.

2. Description of Related Art

The present invention relates to a new-style portable night lamp of an organic light-emitting body. Conventionally, the portable night lamp or illuminating device uses a heat source undesiredly giving off heat (e.g. a light bulb) as a light source. The conventional device has the problems in uniformity of brightness, high-intensity spot light, such as harshness to the human eye, high power consumption and high heat radiation. If an alternative light source is used, a higher driving voltage is generally required. This requirement for higher driving voltage is, however, inconvenient in practice. In addition, the said problems in uniformity of brightness, high power consumption and high heat radiation remain. Hence, the market needs a convenient illuminating device having uniform brightness, low power-consumption and low heat-evolution.

### SUMMARY OF THE INVENTION

The primary object of the present invention is to provide an illuminating device having a light source with easy assembly, uniform brightness, low power-consumption and low heat dissipation.

To attain the above-mentioned object, an illuminating device of the present invention comprises an organic light-emitting panel for providing a light source, a translucent diffusive substrate superposed on a surface of said organic light-emitting panel for uniformly diffusing said light source; and, and a housing having a chamber for receiving said organic light-emitting panel and said translucent diffusive substrate to secure said organic light-emitting panel and said translucent diffusive substrate; wherein a window is arranged in said housing, whereby light emitting from said organic light-emitting panel passes from the chamber to an exterior of said housing, and said translucent diffusive substrate is mounted between said organic light-emitting panel and said housing.

The method for forming the housing of the illuminating device according to the present invention is not specifically limited. Preferably, the housing of the illuminating device of the present invention is made of plastics by injection modeling. The shape of the housing of the illuminating device according to the present invention is not specifically limited, and preferably, shaped as a television mode. The area of the window of the housing of the illuminating device according to the present invention is not specifically limited. Preferably, the area of the window of the housing of the illuminating device is not larger than the light-emitting area or display area of the organic light-emitting panel. The organic light-emitting panel of the illuminating device according to the present invention is not specifically limited, and preferably is an organic light-emitting panel emitting light of a monochrome or an organic light-emitting panel capable of displaying graphics or texts. The translucent diffusive substrate of the illuminating device according to the present invention is not specifically limited, and preferably is a frosted glass formed with an irregular surface by an appropriate surface treatment. The present invention can further comprise a power unit for providing an electric current to drive the organic light-emitting panel. Preferably, the power unit is a battery set. The voltage for driving the organic light-emitting panel of the illuminating device according to the present invention is not specifically limited, and preferably, not larger than ten volts. The application of the illuminating device according to the present invention is not specifically defined, and preferably, used as a light source for decoration or illumination.

The present invention adopts an organic light-emitting body as a light source. The light-emitting body is shaped in the form of planar panel capable of diffusing light uniformly. Furthermore, a layer of translucent diffusive substrate such as frosted glass is superposed on the light-emitting body to moderate the light emitted. The present invention therefore overcomes the problems in prior art high-intensity spot lights, such as harshness to the human eye, high power consumption and high heat radiation as a result of the use of the light bulb as light source for night lamp. In addition, the present invention can be powered by a battery, and thus has the advantage of portability.

To illustrate the present invention, an exemplary embodiment of an illuminating device will now be described with reference to the accompanying drawing.

### BRIEF DESCRIPTION OF THE DRAWING

FIG. 1 is a schematic view of a preferred embodiment of an illuminating device according to the present invention.

### DETAILED DESCRIPTION OF THE PREFERRED EMBODIMENT

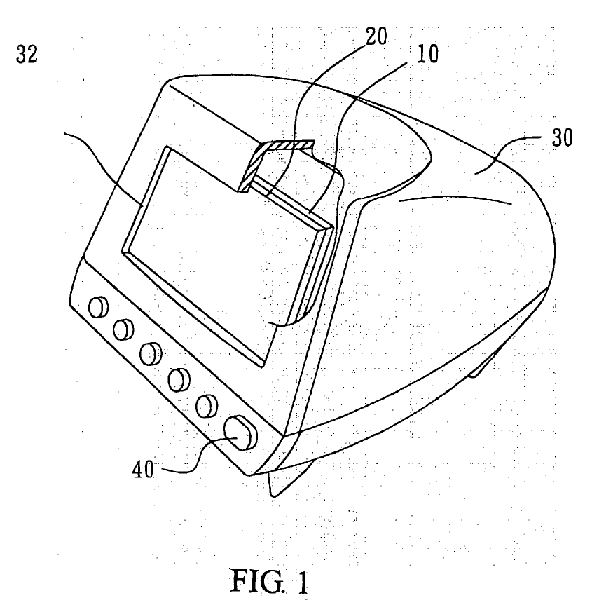

FIG. 1 is a schematic view of a preferred embodiment of an illuminating device according to the present invention. The illuminating device of the present invention comprises a housing 30 having a chamber and a window 32 defined in the housing 30 for communication between the chamber of the housing 30 and an external environment. The chamber of the housing 30 is sufficient to receive an organic light-emitting panel 10 and a frosted glass 20 formed by subjecting a glass sheet to appropriate surface treatment. In the present preferred embodiment, the housing 30 is made of plastic and shaped as a television mode formed by injection modeling. The organic light-emitting panel 10 is used as a light source. The frosted glass 20 is superposed on a surface of the organic light-emitting panel 10, and is mounted between the organic light-emitting panel 10 and the housing 30 to uniformly diffuse the light emitting from the organic light-emitting panel 10. The housing 30 has a chamber for receiving the organic light-emitting panel 10 and the frosted glass 20 to secure the organic light-emitting panel 10 and the frosted glass 20, wherein a window 32 is defined in the housing 30 for light emitting from the organic light-emitting panel to pass from the chamber to an exterior of the housing 30. The frosted glass 20 is mounted between the organic light-emitting panel 10 and the housing 30.

The illuminating device of the present invention can optionally include a power source. Preferably, the power source bas a voltage of less than ten volts and is connected by means of two cables for positive and negative nodes. The power source can be a set of batteries. Or alternatively, the power source may be an external source having a voltage of about six volts resulting from conversion with a transformer. The power source provides an electric current to cause the panel to emit uniform light, which then penetrates the frosted glass and becomes moderated.

Since the light source of the present invention is an organic light-emitting panel, the light of the illuminating device of the present invention is uniform and without high-intensity spot. In addition, by the assistance of the diffusion of the translucent diffusive substrate (e.g. Frosted glass), the emitted light of the illuminating device of the present invention is moderated and suitable for illumination or decoration, especially at night. Furthermore, since the organic light-emitting body merely requires a low voltage (such as a six-volt battery) to be driven. Thus, power consumption is low, and also, the heat radiation of this light source is very low so that electricity can be effectively applied for illumination.

In addition, by combining with another transparent medium with patterned graphics or texts on the surface of the translucent diffusive substrate, the organic light-emitting panel can display graphics or texts. A design of control panel can be added to the housing to display time or have other functions. Hence, the application scope of the present invention can be very extensive.

Although the present invention has been explained in relation to its preferred embodiment, it is to be understood that many other possible modifications and variations can be made without departing from the spirit and scope of the invention as hereinafter claimed.

What is claimed is:

1. An illuminating device, comprising:
an organic light-emitting panel for providing a light source;
a translucent diffusive substrate superposed on a surface of said organic light-emitting panel for uniformly diffusing said light source; and
a housing having a chamber for receiving said organic light-emitting panel and said translucent diffusive substrate to secure said organic light-emitting panel and said translucent diffusive substrate;
wherein a window is arranged in said housing, whereby light emitting from said organic light-emitting panel passes from the chamber to an exterior of said housing, and said translucent diffusive substrate is mounted between said organic light-emitting panel and said housing.

2. The illuminating device as claimed in claim 1, wherein the area of said window of said housing is smaller than the light-emitting area or display area of said organic light-emitting panel.

3. The illuminating device as claimed in claim 1, wherein said organic light-emitting panel is capable of displaying graphics or texts.

4. The illuminating device as claimed in claim 1, wherein said translucent diffusive substrate is a glass having been subjected to roughening surface treatment.

5. The illuminating device as claimed in claim 1, further comprising a power unit for providing an electric current to drive said organic light-emitting panel.

6. The illuminating device as claimed in claim 1, wherein said power unit is a battery set.

7. The illuminating device as claimed in claim 1, wherein said battery set is received within said housing.

8. The illuminating device as claimed in claim 1, wherein said power unit provides said, organic light-emitting panel with a voltage not larger than ten volts to drive said organic light-emitting panel for illumination.
